(19) United States
(12) Patent Application Publication
(10) Pub. No.: US 2016/0306024 A1
(43) Pub. Date: Oct. 20, 2016

(54) Systems and Methods for Sound Event Target Monitor Correlation

(71) Applicant: BI Incorporated, Boulder, CO (US)

(72) Inventors: James J. Buck, JR., Longmont, CO (US); Joseph P. Newell, Louisville, CO (US); Cady Lyn Brooks, Nederland, CO (US)

(21) Appl. No.: 15/059,914

(22) Filed: Mar. 3, 2016

Related U.S. Application Data
(60) Provisional application No. 62/148,703, filed on Apr. 16, 2015.

(51) Int. Cl. G01S 3/80

(52) U.S. Cl. CPC G01S 3/80

(57) ABSTRACT

Various embodiments of the present inventions provide systems and method for correlating monitor information with sound event information.

### CROSS REFERENCE TO RELATED APPLICATION

The present application claims priority to (i.e., is a non-provisional of) U.S. Pat. App. No. 62/148,703 entitled “Systems and Methods for Sound Event Target Monitor Correlation”, and filed Apr. 16, 2015 by Buck et al. The entirety of the aforementioned application is incorporated herein by reference for all purposes.

### BACKGROUND OF THE INVENTION

The present inventions are related to utilizing sound event information, and in particular to systems and methods for correlating monitor information with sound event information.

At times events occur and the only way to determine the cause of the event is to interview individuals that were near the event. In some cases, no individuals are available to interview, and in other cases, those who are available to interview do not have relevant information related to the cause of the event.

Thus, for at least the aforementioned reasons, there exists a need in the art for more advanced approaches, devices and systems for gathering information in relation to an event.

### BRIEF SUMMARY OF THE INVENTION

The present inventions are related to utilizing sound event information, and in particular to systems and methods for correlating monitor information with sound event information.

This summary provides only a general outline of some embodiments of the inventions. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. Many other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a is a block diagram illustrating a monitoring system including sound event location and target location monitoring and correlation in accordance with various embodiments of the present inventions;

FIG. 1b is a block diagram of a target monitor device including pursuit mode support in accordance with one or more embodiments of the present inventions;

FIG. 1c shows a target monitor device including pursuit mode support in accordance with one or more embodiments of the present inventions;

FIG. 2 is a flow diagram depicting a method for sound event determination and target monitoring correlation in accordance with some embodiments of the present inventions;

FIGS. 3a-3c graphically represent example information collected in relation to a sound event in accordance with various embodiments of the present inventions; and

FIG. 4 is an example report showing sound event and target monitor device correlation in accordance with various embodiments of the present inventions.

### DETAILED DESCRIPTION OF THE INVENTION

The present inventions are related to utilizing sound event information, and in particular to systems and methods for correlating monitor information with sound event information.

Various embodiments of the present inventions provide target identification systems that include a monitoring device and a central monitoring system. The monitoring device includes: a location determination circuit operable to identify a time based location of the monitoring device to yield a time based location output; and a controller circuit operable to transmit the time based location output to a central monitoring system. The central monitoring system receives sound event information and the time based location output; identifies a window of time around a sound event time and a region around a sound event location wherein the sound event time and the sound event location are derived from the sound event information; and determines whether the time based location output is within both the window of time and the region. In some cases, the sound event information corresponds to a sound event, and the sound event is a gun shot.

In some instances of the aforementioned embodiments, the location determination circuit includes a GPS location circuit. In one or more instances of the aforementioned embodiments, the location determination circuit includes a earth based location circuit. Such an earth based location circuit may be, but is not limited to, a WiFi based location circuit, an AFLT based location circuit, a cell tower based location circuit, and/or a beacon based location circuit. In some instances of the aforementioned embodiments, the sound event information includes the sound event time and the sound event location. In one or more instances of the aforementioned embodiments, the sound event information includes: a first time stamp and a first location derived from a first sensor, a second time stamp and a second location derived from a second sensor, and a third time stamp and a third location derived from a third sensor. In some such instances, the central monitoring system further triangulates the combination of the first time stamp, the first location, the second time stamp, the second location, the third time stamp, and the third location to calculate the sound event time and the sound event location. In particular instances of the aforementioned embodiments, the target monitor device includes a connection device operable to secure the target monitor device to a target. In one or more instances of the aforementioned embodiments, determining whether the time based location output is within both the window of time and the region result in an indication of a correlation between the target monitor device and a sound event described by the sound event information, and the central monitoring system is further operable to transmit the correlation to a third party recipient.

Other embodiments of the present inventions provide methods for identifying a target. The methods include: receiving a first time based location output by the central monitoring system, where the first time based location is derived from a first monitor device having a first location determination circuit operable to identify a time based location of the first monitor device to yield the first time based location output; receiving a second time based location output by the central monitoring system, where the second time based location is derived from a second monitor device having a second location determination circuit operable to identify a time based location of the second monitor device to yield the second time based location output; receiving sound event information corresponding to a sound event; identifying a window of time around a sound event time and a region around a sound event location, where the sound event time and the sound event location are derived from the sound event information; and determining whether the first time based location output is within both the window of time and the region and whether the second time based location output is within both the window of time and the region.

In some instances of the aforementioned embodiments, the methods further include: securely attaching the first monitor device to a first target and identifying the first monitor device with the first target; and identifying the second monitor device with the second target without securely attaching the second monitor device to the second target. In some such instances, the first monitor device includes a strap to secure the monitor device to a target, and the second monitor device does not include a strap to secure the monitor device to a target. In various instances of the aforementioned embodiments, the sound event information includes the sound event time and the sound event location. In particular instances of the aforementioned embodiments, the sound event information includes: a first time stamp and a first location derived from a first sensor, a second time stamp and a second location derived from a second sensor, and a third time stamp and a third location derived from a third sensor. In some such instances, the method further includes triangulating the combination of the first time stamp, the first location, the second time stamp, the second location, the third time stamp, and the third location to calculate the sound event time and the sound event location. In some cases, the first sensor includes a first microphone, the second sensor includes a second microphone, and the third sensor includes a third microphone.

Yet other embodiments of the present invention provide systems for sound event and target correlation. The systems include a first monitor device and a central monitoring system. The first monitor device includes: a location determination circuit operable to identify a time based location of the first monitor device to yield the first time based location output, and a strap to secure the monitor device to a target. The central monitoring system: receives a first time based location output from the first monitor device; receives a second time based location output by the central monitoring system, where the second time based location is derived from a second monitor device having a location determination circuit operable to identify a time based location of the second monitor device to yield the first time based location output; receives sound event information corresponding to a sound event; identifies a window of time around a sound event time and a region around a sound event location, where the sound event time and the sound event location are derived from the sound event information; and determines whether the first time based location output is within both the window of time and the region and whether the second time based location output is within both the window of time and the region.

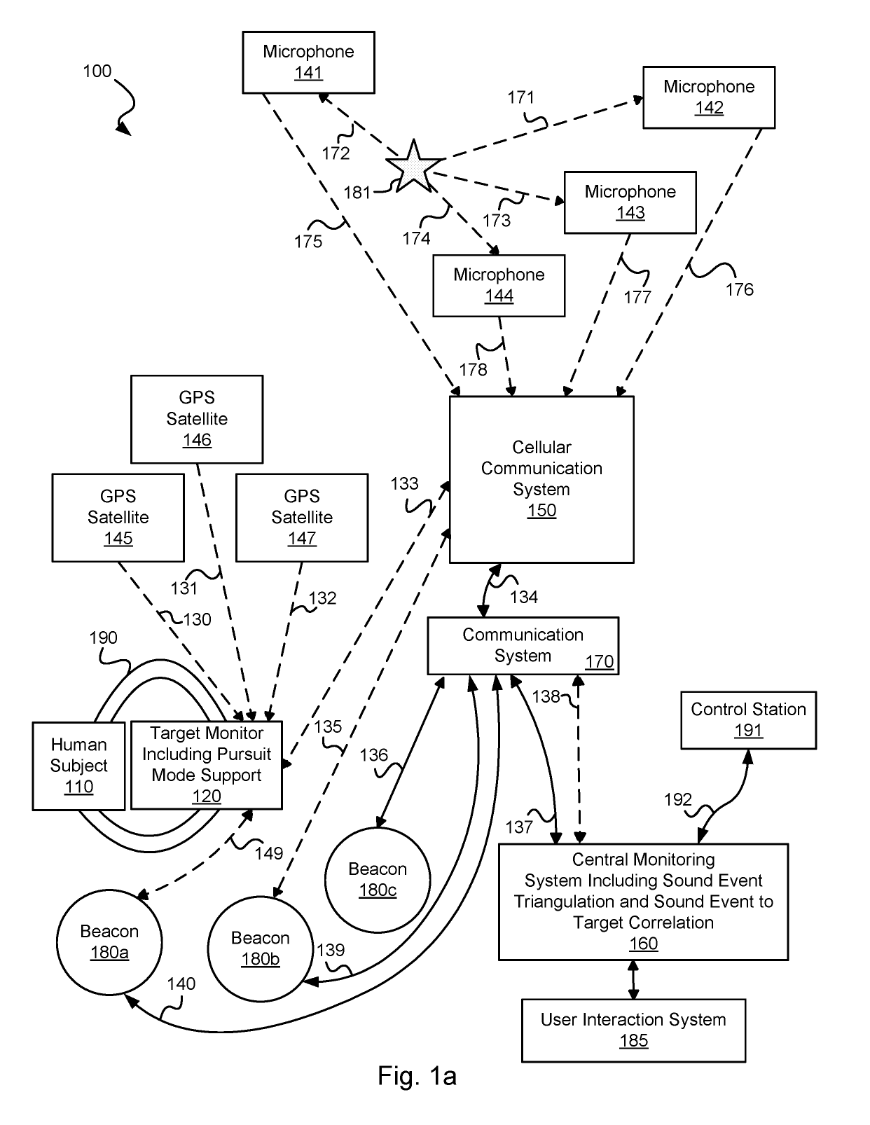

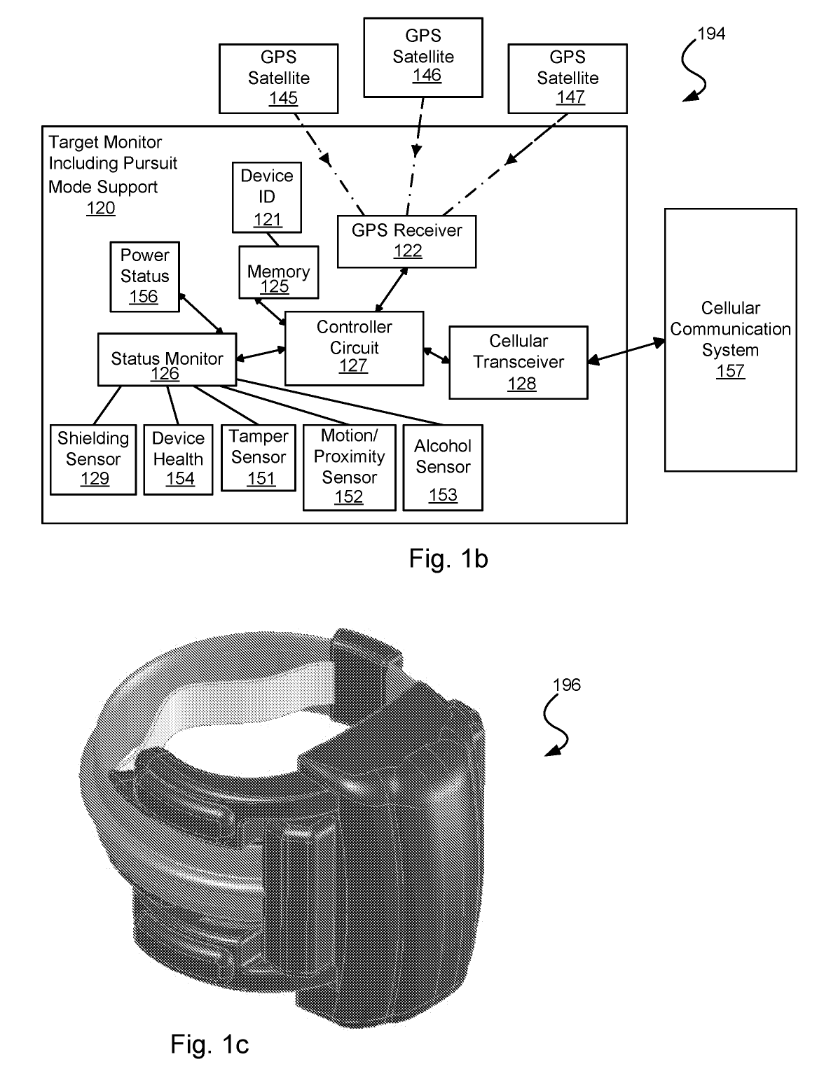

Turning to FIG. 1a, a monitoring system 100 including sound event location and target location monitoring and correlation is shown in accordance with various embodiments of the present invention. Monitoring system 100 may be tailored for tracking human subjects and gun shot sound events, however, it should be noted that various implementations and deployments of monitoring system 100 may be tailored for tracking non-human targets such as, for example, other animals or inanimate assets or objects and/or other sound events. Such inanimate assets or objects may include, but are not limited to, automobiles, boats, equipment, shipping containers or the like and sound events may be those of a car accident. In one particular embodiment, monitoring system 100 is tailored for tracking delivery vehicles. Based upon the disclosure provided herein, one of ordinary skill in the art will recognize a variety of individuals, animals and/or assets that may be monitored in accordance with different embodiments of the present invention, and/or different monitoring scenarios or systems that may be modified to incorporate one or more features disclosed herein.

Monitoring system 100 includes, but is not limited to, multiple target monitors 120 each associated with particular human targets. For convenience, only one of the target monitors 120 is discussed in detail. Target monitor 120 that is physically coupled to a human subject 110 by a securing device 190. In some cases, securing device 190 is a strap that includes a tamper sensor 151 that may be, but is not limited to, a continuity sensor that when broken indicates an error or tamper condition. Further, in some cases, tamper sensor 151 may be implemented as a proximity sensor that is able to detect when it has been moved away from an individual being monitored. When such movement away from the individual is detected, an error or tamper condition may be indicated. Based on the disclosure provided herein, one of ordinary skill in the art will recognize a variety of tamper sensors that may be incorporated in either target monitor 120 or securing device 190 to allow for detection of removal of target monitor 120 or other improper or unexpected meddling with target monitor 120. Further, based upon the disclosure provided herein, one of ordinary skill in the art will recognize a variety of monitors and/or securing devices that may be appropriate where the target of the monitoring is not a human or other animal subject, but rather an asset.

Target monitor 120 is designed to provide the location of human subject 110 under a number of conditions. For example, when target monitor 120 is capable of receiving wireless GPS location information 130, 131, 132 from a sufficient number of GPS satellites 145, 146, 147 respectively, target monitor 120 may use the received wireless GPS location information to calculate or otherwise determine the location of human subject 110. Alternatively or in addition, the location of a beacon 180 that is local to target monitor 120 may be used as the location of target monitor 120. As yet another alternative, an AFLT (i.e., advanced forward link trilateration) fix may be established based on cellular communication with target monitor 120. It should be noted that other types of earth based triangulation may be used in accordance with different embodiments of the present invention. Based on the disclosure provided herein, one of ordinary skill in the art will recognize other types of earth based triangulation that may be used.

As yet another alternative, an AFLT fix may be established based on cellular communications between target monitor 120 and a cellular communication system 150. Furthermore, when wireless communication link 133 between target monitor 120 and cellular communications system 150 is periodically established, at those times, target monitor 120 may report status and other stored records including location fixes to a central monitoring system 160 via one or both of a hardwired communication link 137 and/or wireless communication link 138. Central monitoring system includes a database of time based location information for a number of target monitor devices, and circuitry to define a time window around a sound event and a region around a sound event, and to determine which if any target monitor devices were within both the window and the region.

Monitoring system 100 includes, but is not limited to, at least one beacon 180. Beacons 180 are instrumental for beacon based monitoring systems. Within FIG. 1, a telemetric wireless link 149 has been depicted between beacon 180a and target monitor 120. Each beacon 180 has an adjustable range to make telemetric wireless contact with target monitor 120. At any point in time, depending on each beacon's 180 relative distance to target monitor 120, none, one, or more than one tracking beacons 180 may be within transmission range of a single target monitor 120. Likewise, it is further conceivable under various circumstances that more than one target monitor 120 at times be within in range of a solitary beacon 180.

Telemetric wireless communications path 149 established at times between tracking beacon 180a and target monitor 120 illustrates a common feature of various different embodiments of the current invention. Some embodiments of the various inventions vary on how (i.e., protocol) and what information and/or signaling is passed over wireless communications path 149. For example, in more simplified configurations and embodiments, each beacon 180 is limited to repetitively transmitting its own beacon ID and physical location information. In that way, once target monitor 120 is within transmission range of tracking beacon 180a and establishes wireless or wired reception via link 149, then target monitor 120 can record and store received beacon ID and location information. At a later time, for some embodiments of the present invention, target monitor 120 can then report recorded readings from beacons 180 to the central monitoring system 160 over the cellular communication system 150 using wireless links 133 and 138 as depicted in FIG. 1. Furthermore, many embodiments allow for such transmissions and information passing to occur without being noticed by human subject 110, and unnoticed, automatically, and near effortlessly central monitoring system 160 is able to establish records and track human subject's 110 movements and whereabouts.

In other embodiments or configurations according to the present invention, each beacon 180 also transmit status information related to its own device health and information related from each beacon's 180 internal tampering, movement, or other sensors via a communication system 170 to central monitoring system 160. This allows for detection of movement of beacons 180, and establishing some level of confidence that the location reported by each of beacons 180 is accurate. Various other details about a beacon based system are disclosed in U.S. patent application Ser. No. 12/041,746 entitled “Beacon Based Tracking Devices and Methods for Using Such” and filed Mar. 4, 2008 by Buck et al. The entirety of the aforementioned reference is incorporated herein by reference for all purposes.

Likewise, in some other embodiments, each target monitor 120 contains a host of their own power status, tampering, shielding, movement, and/or other sensors related to its own device health. While still further embodiments also include a host of other measurement transducers within target monitor 120 for extracting information, and for later reporting, related to physical properties of human subject 110. For example, measuring for the presence of alcohol and/or other drugs present in human subject 110 may be included in some embodiments of target monitor 120. As one example, the alcohol sensor discussed in U.S. Pat. No. 7,930,927 entitled “Transdermal Portable Alcohol Monitor and Methods for Using Such” and filed by Cooper et al. on Mar. 4, 2008. The entirety of the aforementioned reference is incorporated herein by reference for all purposes.

Beacons 180 in alternative embodiments of the present invention may communicate with central monitoring system 160 independently of target monitor 120. The monitoring system 100 illustrated in FIG. 1a shows beacon 180b having both a wireless communication link 135 with cellular communication system 150, and also illustrates beacon 180b having a hardwired communication link 139 with communication system 170. Monitoring system 100 is also shown with beacons 180a, 180b, and 180c each having hardwired communication links 140, 139, and 136 respectively to communication system 170. Monitoring system 100 further illustrates communication system 170 having a hardwired communication link 134 to cellular communication system 150, and a hardwired communication link 137 to central monitoring system 160.

In some embodiments of the present invention, beacons 180 are located in areas frequented by human subject 110 where target monitor 120 is incapable of accessing information from the GPS system. Such beacons eliminate the need to perform an AFLT fix and avoid the costs associated therewith. As an example, human subject 110 may have a tracking beacon 180 placed within his home, and one also placed at his place of employment in close proximity to his work area. In this way, the two placed beacons, each at different prescribed times, can interact with his attached target monitor 120 to periodically make reports to central monitoring system 160 to track movements and the whereabouts of human subject 110. All this can be done without incurring the costs associated with performing an AFLT fix.

In addition, monitoring system 100 includes a sound triangulation system that includes a number of sound sensors labeled as microphones 141, 142, 143, 144. Each of microphones 141, 142, 143, 144 sense sound waves (indicated as 171, 172, 173, 174) generated due to a sound event 181. In some cases, sound event 181 may be a gun shot or other prominent sound. Each of microphones 141, 142, 143, 144 record an amplitude and frequency of the sound received along with a high resolution time stamp of when the sound was received. This recorded information is transferred via respective cellular telephone links 175, 176, 177, 178 to cellular communication system 150, and from there to central monitoring system 160. It should be noted that the information may be sent via other communication links such as, for example, wired links, optical links, or WiFi links. Based upon the disclosure provided herein, one of ordinary skill in the art will recognize a variety of communication mechanisms that may be used to transfer information from microphones 141, 142, 143, 144 for additional processing.

It should be noted that while monitoring system 100 is shown with information derived from each of microphones 141, 142, 143, 144 being transmitted directly to central monitoring system 160 via intervening communications systems 150, 170, that a sound event triangulation system (not shown) may be implemented separate from central monitoring system 160. In such an alternative system, the information from of microphones 141, 142, 143, 144 would be transferred to the sound event triangulation system, and the sound event triangulation system would transfer the resulting time stamped location data for the sound event to central monitoring system 160.

Monitoring system 100 further includes a control station 191 that is communicably coupled to central monitoring system 160 via a communication link 192. In one particular embodiment of the present invention, control station 191 is a personal computer including a display device, a processor, and/or one or more I/O devices. Based upon the disclosure provided herein, one of ordinary skill in the art will recognize a variety of systems that may be used as control station 191 including highly tailored application specific control systems. A storage medium is included as part of control station 191 and maintains instructions governing the operation of pursuit mode control in relation to central monitoring system 160 and target monitor 120.

Central monitoring system 160 includes functionality for identifying a location and time of sound event 181. The location and time of the sound event is calculated based upon information from microphones 141, 142, 143, 144. In some embodiments of the present inventions, the combination of the amplitude, frequency and time stamp data from each of the microphones is combined with the known location of the microphones to calculate the location and time of sound event 181. It should be noted that any technology for identifying the location and time of a sound event may be used in relation to different embodiments of the present inventions. Based upon the disclosure provided herein, one of ordinary skill in the art will recognize a variety of systems including a sound triangulation system that may be used in relation to different embodiments of the present invention.

In addition, central monitoring system 160 includes functionality for identifying which, if any, of the multiple target monitor devices 120 were within a defined physical and time proximity of sound event 181. Yet further, central monitoring system 160 includes functionality for sending alerts to a user interaction system 185 when a tracked target ventures into a prohibited zone as updated by the adaptive zone update control, for providing location information indicating a location of target monitor 120, for issuing an alert when a sound event is detected, and/or for providing correlated sound event and target location information. Based upon the disclosure provided herein, one of ordinary skill in the art will recognize a variety of user interaction systems 185 that may be used in relation to one or more of the embodiments discussed herein. Further, it should be noted that such a system is not limited to use in relation to law enforcement.

Turning to FIG. 1b, a block diagram 194 of target monitor device 120 including pursuit mode support is shown in accordance with one or more embodiments of the present invention. As shown, target monitor device 120 includes a device ID 121 that may be maintained in a memory 125, and thus is accessible by a controller circuit 127. Controller circuit 127 is able to interact with GPS receiver 122 and memory 125 at times for storing and generating records of successively determined GPS locations. Where target monitor 120 is operating in a standard mode, controller circuit 127 causes an update and reporting of the location of target monitor device via a cellular transceiver 128 and a cellular communication system 157 in accordance with a first time period. In contrast, where target monitor 120 is operating in a pursuit mode, controller circuit 127 causes an update and reporting of the location of target monitor device via cellular transceiver 128 and cellular communication system 157 in accordance with a second time period. The second time period is substantially shorter than the first time period. In one particular embodiment of the present invention, the first time period is approximately three minutes and the second time period is approximately every fifteen seconds. Based upon the disclosure provided herein, one of ordinary skill in the art will recognize other durations for the first time period and the second time period in accordance with different embodiments of the present invention. In some embodiments of the present invention, one or both of the first time period and the second time period is/are user programmable. Operating target monitor device 120 in the pursuit mode consumes substantially more power than in the standard mode. Controller circuit 127 may be, but is not limited to, an application specific circuit configured to perform control functions for target monitor. Memory 125 may be any type of memory known in the art such as, for example, a EEPROM or RAM memory. In some cases where controller circuit 127 executes instructions, such instructions may be maintained in memory 125.

Controller circuit 127 of target monitor 120 at times functions in conjunction with cellular transceiver 128 to send and receive data and signals through cellular communication system 190. This link at times is useful for passing information and/or control signals between a central monitoring system (not shown) and multi-purpose monitoring device 120. The information transmitted may include, but is not limited to, location information, alcohol information, and information about the status of multi-purpose monitoring device 120. Based on the disclosure provided herein, one of ordinary skill in the art will recognize a variety of information that may be transferred via cellular communication system 190.

Various embodiments of target monitor 120 include a variety of sensors capable of determining the status of target monitor 120, and of the individual associated therewith. For example, a status monitor 126 may include one or more of the following subcomponents: a power status sensor 156 capable of indicating a power status of target monitor 120. The power status may be expressed, for example as a percentage of battery life remaining. Based upon the disclosure provided herein, one of ordinary skill in the art will recognize a variety of forms in which power status may be expressed. In addition, target monitor 120 includes a set of shielding sensors 129 that are capable of determining whether target monitor 120 is being shielded from receiving GPS signals and/or if GPS jamming is ongoing, a set of device health indicators 154, a tamper sensor 151 capable of determining whether unauthorized access to target monitor 120 has occurred or whether target monitor 120 has been removed from an associated human subject, a motion/proximity sensor 152 capable of determining whether target monitor 120 is moving and/or whether it is within proximity of an individual associated with target monitor 120, and/or an alcohol sensor 153 such as that described herein. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into target monitor 120 according to various different instances and/or embodiments of the present invention. Turning to FIG. 1c, one implementation 196 of a combination of target monitor 120 and strap 190 is shown in accordance with one or more embodiments of the present invention. Based upon the disclosure provided herein, one of ordinary skill in the art will recognize a variety of a target monitor that may be used in relation to different embodiments of the present inventions. For example, in another embodiment, the target monitor may be a device that reports a presumed identity of an individual in possession of the device and a location at the device at different times.

It should be noted that while the system is discussed as using a human attached target monitor device, that various embodiments of the present invention may be designed that take location information from one or more non-human attached target monitor devices. Such non-human attached target monitor devices would be capable of indicating a person who is associated with the device and time based locations of the target monitor device. In one particular embodiment, a mobile device with cellular communication with GPS location capability may be used.

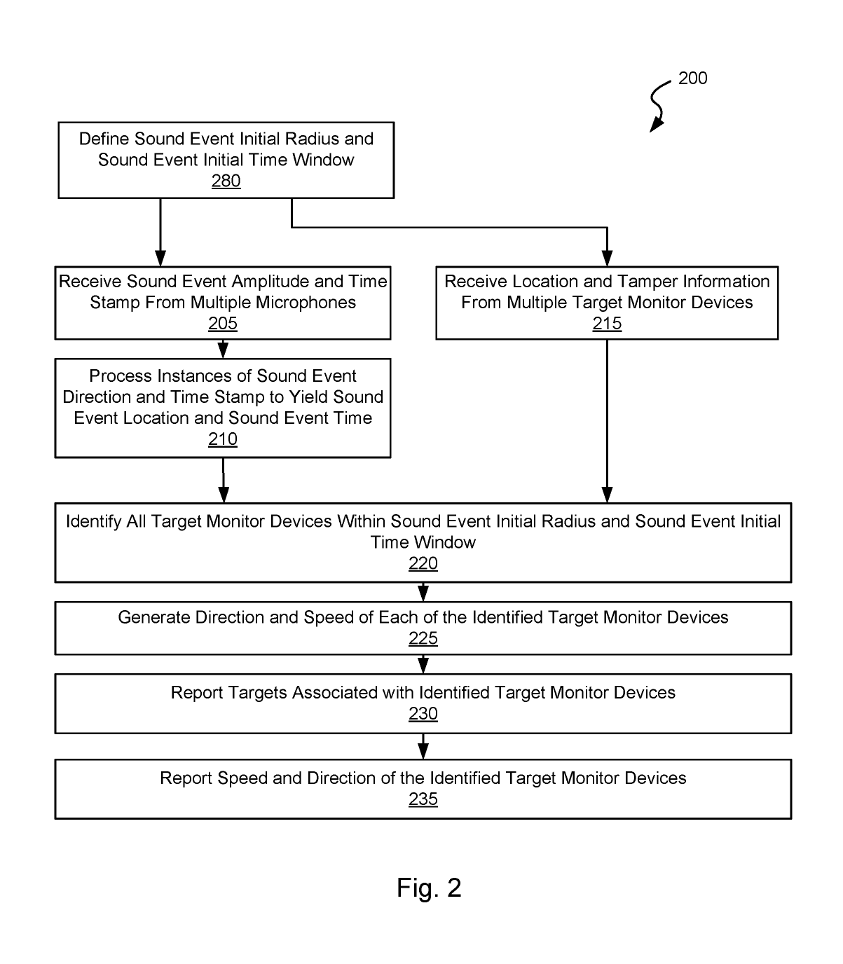

Turning to FIG. 2, a flow diagram 200 depicts a method for sound event determination and target monitoring correlation in accordance with some embodiments of the present inventions. Following flow diagram 200, a sound event initial radius and sound event initial time window are defined (block 280). The sound event initial radius defines a physical region extending from the location of the sound event to an outer radius (i.e., R) where relevant activity of target monitor devices is desired. The sound event initial time window defines a window of time extending from before a sound event until after a sound event (i.e., tn to tm, where tn is before the event and tm is after the event) where relevant activity of target monitor devices is desired. In some cases, default values for the sound event initial radius, and the sound event initial time window are used. In one particular case, a sound event initial radius of one mile is used, and a sound event initial time window of +/−60 (i.e., tn equals the sound event time less 60 minutes, and equals the sound event time plus 60 minutes) is used. Based upon the disclosure provided herein, one of ordinary skill in the art will recognize other raddii and time windows that may be used in relation to different embodiments of the present inventions.

The respective amplitudes and time stamps of a sound event as recorded by multiple microphones are received (block 205), and the received data is processed to yield a sound event location and a sound event time (block 210). In some embodiments of the present inventions, the combination of the amplitude and time stamp data (and in some cases frequency information) from each of the microphones is combined with the known location of the microphones to calculate the location and time of sound event 181. It should be noted that any technology for identifying the location and time of a sound event may be used in relation to different embodiments of the present inventions. Based upon the disclosure provided herein, one of ordinary skill in the art will recognize a variety of systems including a sound triangulation system that may be used in relation to different embodiments of the present invention.

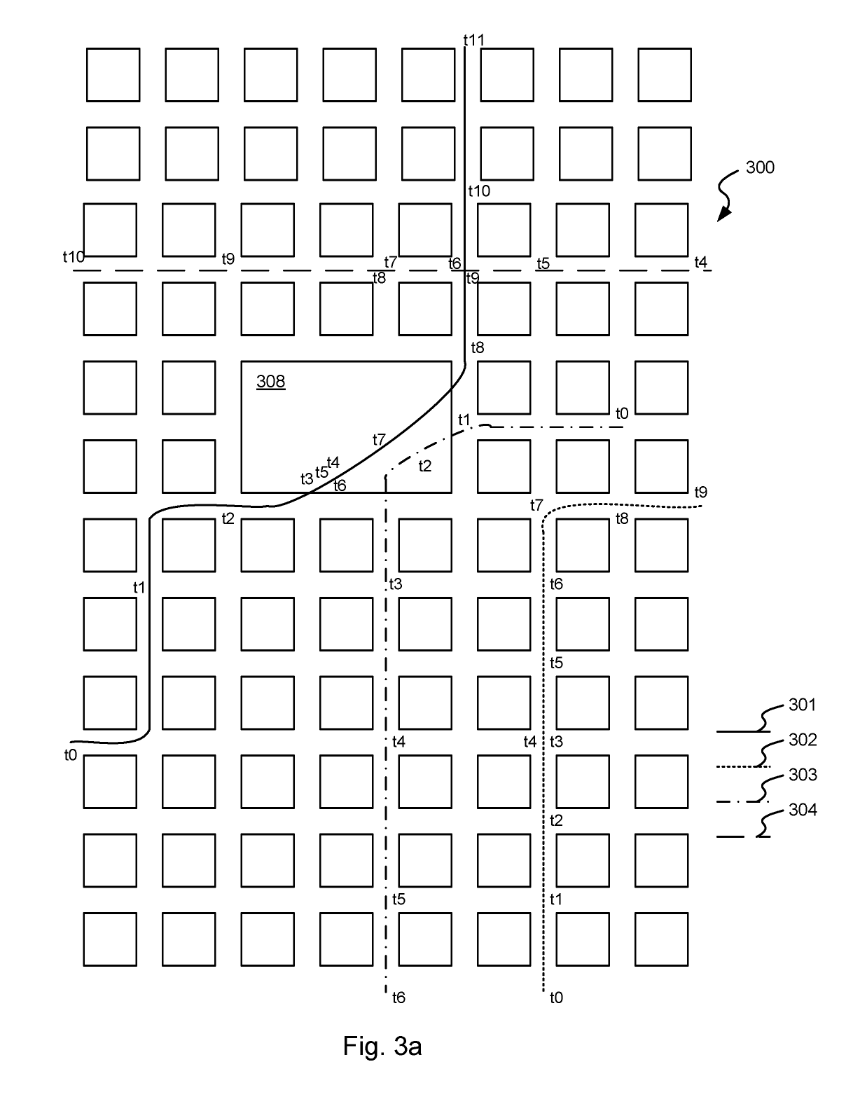

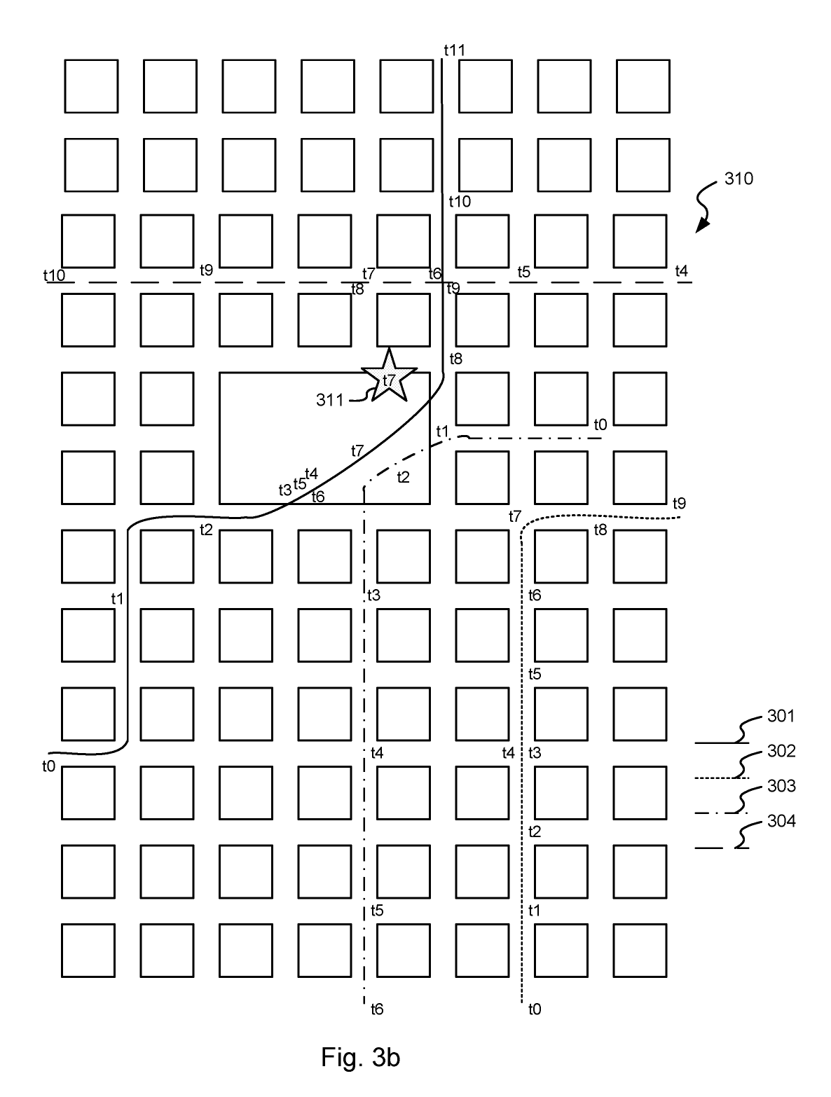

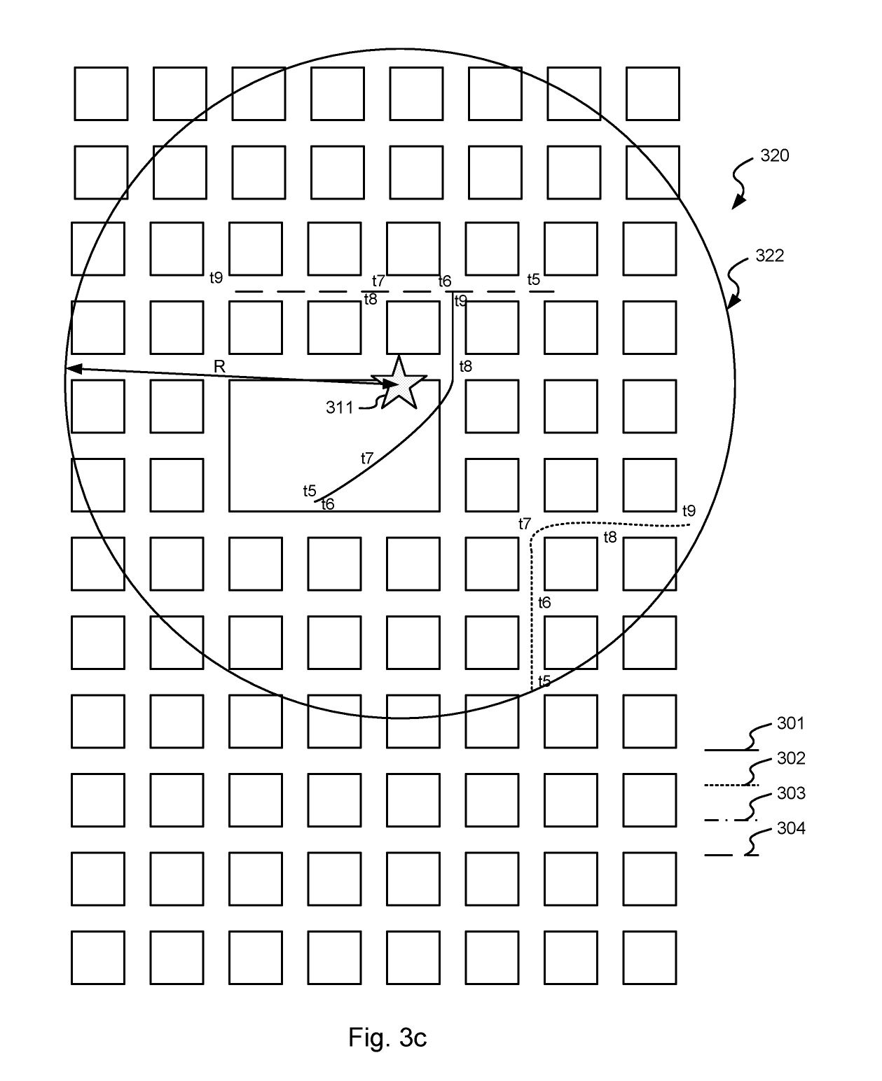

In parallel, location and tamper information is being received from multiple target monitor devices (block 215). Turning to FIG. 3a, a graphic 300 shows a region being crossed by a number of targets (i.e., a target 301 represented by a solid line, a target 302 represented by a finely dotted line, a target 303 represented by an intermittent line, and a target 304 represented by a coarse dashed line) at different times (i.e., times t0-t11 which represent twelve equal increments in time). In particular, target 301 enters the region at time t0 going east, and turns north between a time t0 and t2. At a time t1 target 301 is moving north. Between time t1 and t3 target 301 is moving east. Between times t2 and t8 target 301 crosses an open area 308. During this time the movement of target 301 is erratic moving forward and backward with an overall change in distance being very small as noted by times t3, t4, t5, t6, t7. From times t8 through t11 target 301 moves north ultimately leaving the region. Target 302 enters the region at time t0 moving north at a relatively constant rate as indicated by the similar distances between times t0, t1, t2, t3, t4, t5, t6 and t7. Between times t6 and t8 target 302 turns east and continues at about the same rate as indicated by the similar distances between times t7, t8 and t9. Target 303 was already in the region at time t0 and moves west until time t1 when target 303 moves through open area 308, ultimately turning south between times t2 and t3. Target 303 continues south at a relatively constant rate as indicated by similar distances between times t2, t3, t4, t5, ultimately leaving the area at a faster pace at time t6. Target 304 enters the region at time t4 going west and maintains that course through times t5, t6, t7, t8, t9 and t10. The rate at which target 304 is moving changes as indicated by the relative distances between the times t4, t5, t6, t7, t8, t9 and t10, with the subject slowing between times t6 and t7, stopping between times t7 and t8, and moving rapidly between times T8 and t9. Turning to FIG. 3b, an identified sound event 311 is placed on the graphic of FIG. 3a to yield a graphic 310. Sound event 311 is identified at the northeast corner of open area 308 and happens at a time t7.

Returning to FIG. 2, all target monitor devices within the sound event initial radius at any point during the sound event initial time window are identified (block 220). Turning to FIG. 3c, a graphic 320 shows the graphic of FIG. 3b overlaid by a region 322 representing a sound even initial radius (identified as R on graphic 320) extending from the location of sound event 311. The movement of targets within region 322 is of interest. In addition, the sound event initial time window is selected as a window two time periods before the occurrence of sound event 311 and two time periods after the occurrence of sound event 311 (i.e., from times t5-t9). All movement outside of either the sound event initial radius (i.e., outside of region 322) or the sound event initial time window (i.e., outside of times t5-t9) are eliminated from consideration. This leaves the movement of target 301, target 302 and target 304 between times t5 and t9 under consideration as shown in graphic 320. Returning to FIG. 2, the direction and speed of movement of each of the identified target monitor devices is generated (block 225). This includes calculating the rate of movement of the targets under consideration. Targets associated with the identified target monitor devices are reported (block 230) along with the corresponding speeds and direction of movement (block 235).

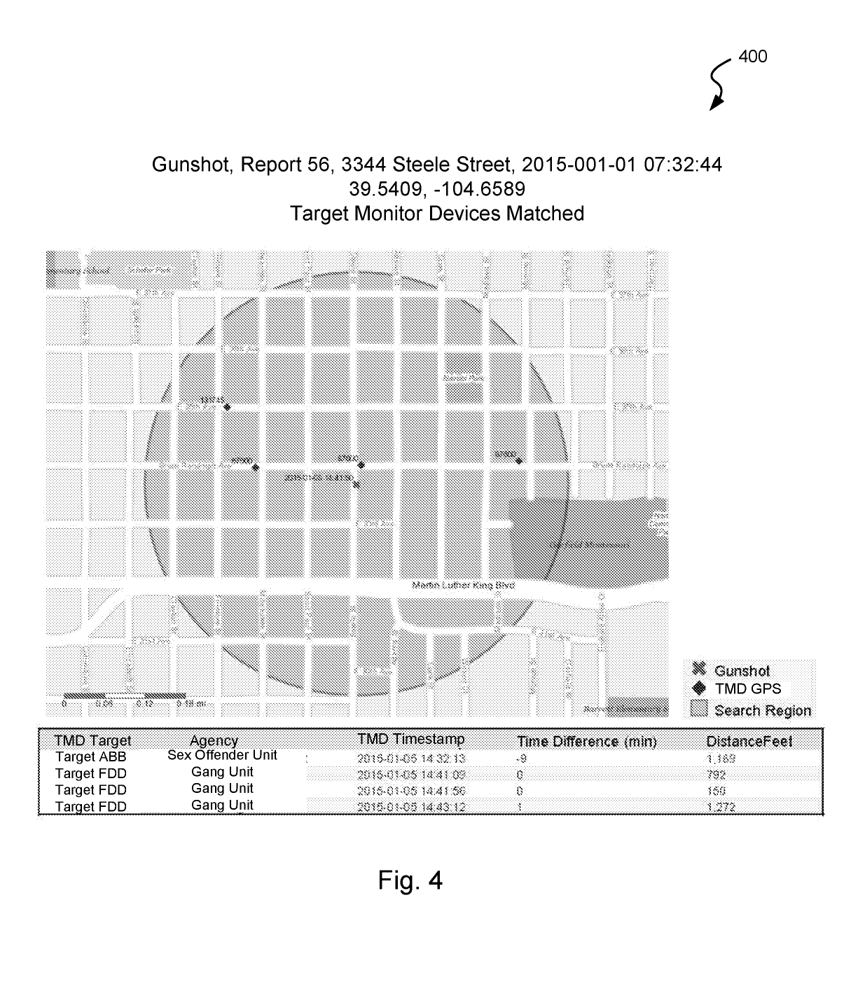

Turning to FIG. 4, an example report 400 graphically depicts a sound event and target monitor device correlation in accordance with various embodiments of the present invention. As shown, example report 400 indicates a gunshot at a particular time and location, and provides time and location information (i.e., TMD GPS) for any target monitor device identified as being within the sound event initial radius at any time during the sound event initial time window. A darker circular region indicates the sound event initial radius extending around the location of the sound event identified as an X. As shown, two targets (i.e., target ABB associated with one target monitor device, and target FDD associated with another target monitor device) reported locations within the sound event initial radius during the sound event initial time window. In this case, one of the targets (target FDD) reported three times within the sound event initial time window of being within the sound event initial radius.

In conclusion, the present invention provides for novel systems, devices, and methods for monitoring individuals and/or assets. While detailed descriptions of one or more embodiments of the invention have been given above, various alternatives, modifications, and equivalents will be apparent to those skilled in the art without varying from the spirit of the invention. For example, the Wi-Fi based positioning may be replaced by or may be augmented by another RF source based triangulation such as, for example, TV towers, radio towers, or the like. Therefore, the above description should not be taken as limiting the scope of the invention, which is defined by the appended claims.

What is claimed is:

1. A target identification system, the target identification system comprising:
a monitoring device includes:
a location determination circuit operable to identify a time based location of the monitoring device to yield a time based location output;
a controller circuit operable to transmit the time based location output to a central monitoring system;
the central monitoring system operable to:
receive sound event information and the time based location output;
identify a window of time around a sound event time and a region around a sound event location, wherein the sound event time and the sound event location are derived from the sound event information; and
determine whether the time based location output is within both the window of time and the region.

2. The target identification system of claim 1, wherein the location determination circuit includes a GPS location circuit.

3. The target identification system of claim 1, wherein the location determination circuit includes a earth based location circuit.

4. The target identification system of claim 1, wherein the earth based location circuit includes one or more location circuits selected from a group consisting of: an AFLT based location circuit, and a cell tower based location circuit.

5. The target identification system of claim 1, wherein the sound event information includes the sound event time and the sound event location.

6. The target identification system of claim 1, wherein the sound event information includes: a first time stamp and a first location derived from a first sensor, a second time stamp and a second location derived from a second sensor, and a third time stamp and a third location derived from a third sensor.

7. The target identification system of claim 6, wherein the central monitoring system is further operable to triangulate the combination of the first time stamp, the first location, the second time stamp, the second location, the third time stamp, and the third location to calculate the sound event time and the sound event location.

8. The target identification system of claim 1, wherein the target monitor device includes a connection device operable to secure the target monitor device to a target.

9. The target identification system of claim 1, wherein determining whether the time based location output is within both the window of time and the region result in an indication of a correlation between the target monitor device and a sound event described by the sound event information, and wherein the central monitoring system is further operable to report the correlation.

10. The target identification system of claim 1, wherein the sound event information corresponds to a sound event, and wherein the sound event is a gun shot.

11. A method for identifying a target, the method comprising:
receiving a first time based location output by the central monitoring system, wherein the first time based location is derived from a first monitor device having a first location determination circuit operable to identify a time based location of the first monitor device to yield the first time based location output;
receiving a second time based location output by the central monitoring system, wherein the second time based location is derived from a second monitor device having a second location determination circuit operable to identify a time based location of the second monitor device to yield the second time based location output;
receiving sound event information corresponding to a sound event;
identifying a window of time around a sound event time and a region around a sound event location, wherein the sound event time and the sound event location are derived from the sound event information; and
determining whether the first time based location output is within both the window of time and the region and whether the second time based location output is within both the window of time and the region.

12. The method of claim 11, the method further comprising:
securely attaching the first monitor device to a first target;
identifying the first monitor device with the first target; and
identifying the second monitor device with the second target without securely attaching the second monitor device to the second target.

13. The method of claim 12, wherein the first monitor device includes a strap to secure the monitor device to a target, and wherein the second monitor device does not include a strap to secure the monitor device to a target.

14. The method of claim 11, wherein the sound event information includes the sound event time and the sound event location.

15. The method of claim 11, wherein the sound event information includes: a first time stamp and a first location derived from a first sensor, a second time stamp and a second location derived from a second sensor, and a third time stamp and a third location derived from a third sensor.

16. The method of claim 15, the method further comprising:
triangulating the combination of the first time stamp, the first location, the second time stamp, the second location, the third time stamp, and the third location to calculate the sound event time and the sound event location.

17. The method of claim 15, wherein the first sensor includes a first microphone, the second sensor includes a second microphone, and the third sensor includes a third microphone.

18. The target identification system of claim 1, wherein the sound event information corresponds to a sound event, and wherein the sound event is a gun shot.

19. The method of claim 11, wherein the location determination circuit includes one or more location circuits selected from a group consisting of: a GPS location circuit, an AFLT based location circuit, and a cell tower based location circuit.

20. A system for sound event and target correlation, the system comprising:
a first monitor device having: a location determination circuit operable to identify a time based location of the first monitor device to yield the first time based location output, and a strap to secure the monitor device to a target;
the central monitoring system operable to:
receive the first time based location output from the first monitor device;
receive a second time based location output by the central monitoring system, wherein the second time based location is derived from a second monitor device having a location determination circuit operable to identify a time based location of the second monitor device to yield the first time based location output;
receive sound event information corresponding to a sound event;
identify a window of time around a sound event time and a region around a sound event location, wherein the sound event time and the sound event location are derived from the sound event information; and
determine whether the first time based location output is within both the window of time and the region and whether the second time based location output is within both the window of time and the region.
